(19) United States
(12) Patent Application Publication
(10) Pub. No.: US 2025/0085966 A1
(43) Pub. Date: Mar. 13, 2025

(54) Device Management System and Program Management Method Thereof

(71) Applicant: LG Energy Solution, Ltd., Seoul (KR)

(72) Inventors: Jaehyeong Son, Daejeon (KR); Ho Soo Kim, Daejeon (KR); Jinhyuk An, Daejeon (KR); Duksu Kim, Daejeon (KR)

(73) Assignee: LG Energy Solution, Ltd., Seoul (KR)

(21) Appl. No.: 18/728,508

(22) PCT Filed: Jun. 19, 2023
(86) PCT No.: PCT/KR2023/008431

§ 371 Date: Jul. 12, 2024

(30) Foreign Application Priority Data
Nov. 30, 2022 (KR) 10-2022-0164431

(51) Int. Cl. G06F 8/71

(52) U.S. Cl. CPC G06F 8/71

(57) ABSTRACT

A device management system configured to interconnect with a device may include at least one processor; and a memory configured to store a device management program including at least one instruction executed by the at least one processor. The at least one processor may be configured to store a first program and a second program independently in separately partitioned areas in the memory, wherein the first program is related to functional safety of the device and the second program is unrelated to the functional safety of the device.

### CROSS-REFERENCE TO RELATED APPLICATION

The present application is a national phase entry under 35 U.S.C. § 371 of International Application No. PCT/KR2023/008431 filed Jun. 19, 2023, published in which claims priority from Korean Patent Application No. 10-2022-0164431 filed in the Korean Intellectual Property Office on Nov. 30, 2022, the entire contents of which are incorporated herein by reference.

### TECHNICAL FIELD

The present invention relates to a device management system and a program management method thereof, and more particularly, to a device management system including a partitioned memory and a program management method system using the memory.

### BACKGROUND ART

An energy storage system relates to various technologies, including renewable energy, a battery that stores electric power, and a power grid. Recently, as supply of smart grid and renewable energy is expanding, and efficiency and stability of power systems are emphasized, a demand for energy storage systems for power supply and demand control and power quality improvement is increasing. Depending on a purpose of use, energy storage systems may have different output and capacity. In order to configure a large-capacity energy storage system, a plurality of battery systems may be connected to provide the large-capacity energy storage system.

For example, an energy storage system applied to a photovoltaic (PV) system may include a battery section composed of a plurality of batteries, a battery management system (BMS) for battery management, a power conversion system (PCS), an energy management system (EMS), a DC-DC converter, and the like.

Among them, the battery management system is a core component for managing batteries which collects state information of batteries included in the battery system, diagnoses failure based on the state information, and controls the operating state of the battery through interworking with a higher controller.

The battery management system may perform predefined operations through a management program (e.g., firmware) stored in a memory. During operation of the battery system, a management program may be updated to change or add a specific function.

The battery management system is subject to functional safety certification in accordance with relevant laws and regulations, and additional certification is required when the management program is updated. In this case, there arises a problem in that unnecessary time and cost are consumed because a functional safety certification procedure should be performed even when a function unrelated to the functional safety item is updated.

### SUMMARY

### Technical Problem

To obviate one or more problems of the related art, embodiments of the present disclosure provide a device management system that manages a device management program using a partitioned memory.

To obviate one or more problems of the related art, embodiments of the present disclosure also provide a program management method of the device management system.

### Technical Solution

In order to achieve the objective of the present disclosure, a device management system configured to interconnected with a device may include at least one processor; and a memory configured to store a device management program including at least one instruction executed by the at least one processor.

Here, the at least one processor may be configured to store a first program and a second program independently in separately partitioned areas in the memory, wherein the first program is related to functional safety of the device and the second program is unrelated to the functional safety of the device.

The at least one processor may be configured to independently store version information of the first program and version information of the second program in separately partitioned areas of the memory.

The at least one processor may be configured to in response to at least one of the first program and the second program being updated, update the version information of the updated first program or the second program.

When an update mode of the device management program is initiated, the at least one processor may be configured to in response to only one of the first program or the second program requiring an update, update the one of the first program or the second program that requires the update; and in response to both the first program and second program requiring an update, update the first program before the second program.

Here, the partitioned areas of the memory include a first area in which the first program is stored and a second area in which the second program is stored; and the first area may be assigned to a fixed specific location on the memory.

Each of the first area and the second area may include: a verification information storage area in which verification information about whether data stored in each area is changed; a code storage area for storing control logic for the device; and data storage area for storing data necessary for management or control of the device.

Here, a first code storage area included in the first area may store diagnosis logic related to the functional safety of the device, and a first data storage area included in the first area may store set values related to the diagnosis logic.

The at least one processor may be configured to update verification information stored in a first verification information storage area of the first area when the data stored in at least one of the first code storage area and the first data storage area is changed.

The memory may correspond to a non-volatile memory.

The device management system may correspond to a battery management system located within a battery system.

According to another embodiment of the present disclosure, a program management method of a device management system including at least one processor and a memory for storing a device management program, the program management method may include: storing, by the processor, a first program and a second program independently in separately partitioned areas in the memory, wherein the first program is related to a functional safety of the device and the second program is unrelated to the functional safety of the device; and storing, by the processor, version information of the first program and version information of the second program independently, in the separately partitioned areas of the memory.

The program management method may further include independently updating only version information of an updated program, in response to at least one of the first program and the second program being updated.

The program management method may further include determining one of the first program and the second program as an update target program when an update mode of the device management program is initiated; and independently updating the determined update target program.

The program management method may further comprise include allocating an area where the first program is stored to a fixed specific location on the memory.

The memory may include a first area in which the first program is stored; and a second area in which the second program is stored. Here, each of the first area and the second area may include: a verification information storage area in which verification information about whether data stored in each area is changed; a code storage area for storing control logic for the device; and data storage area for storing data necessary for management or control of the device.

The program management method may further comprise storing diagnosis logic related to the functional safety of the device in a first code storage area included in the first area and storing set values related to the diagnosis logic in a first data storage area included in the first area.

The method may further include updating verification information stored in a first verification information storage area of the first area when the data stored in at least one of the first code storage area and the first data storage area is changed.

### Advantageous Effects

According to embodiments of the present disclosure, when updating a device management program, it is possible to independently update only some of the functions that need to be changed, by separating the device management program into a functional safety related program and a general program and managing them independently, thereby improving program management efficiency.

In addition, according to embodiments of the present invention, unnecessary certification procedures can be minimized by performing a functional safety certification procedure only when a functional safety related program included in the device management program is updated.

### BRIEF DESCRIPTION OF THE DRAWINGS

FIG. 1 is a block diagram of an energy storage system to which the present invention may be applied.

FIG. 2 is a block diagram of a memory included in a typical battery management system.

FIG. 3 is a block diagram of a device management system according to embodiments of the present invention.

FIG. 4 is a block diagram of a memory included in a device management system according to embodiments of the present invention.

FIG. 5 illustrates partitioned areas of memory according to embodiments of the present invention.

FIG. 6 shows an example of a memory according to embodiments of the present invention.

FIG. 7 is an operation flowchart of a program management method according to embodiments of the present invention.

100: processor
200: memory
210: first area
211: first verification information storage area
212: first code storage area
213: first data storage area
220: second area
221: second verification information storage area
222: second code storage area
223: second data storage area
300: transceiver
400: input interface
500: output interface
600: storage device
700: bus

### DETAILED DESCRIPTION

The present invention may be modified in various forms and have various embodiments, and specific embodiments thereof are shown by way of example in the drawings and will be described in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes combinations of a plurality of associated listed items or any of the plurality of associated listed items.

It will be understood that when an element is referred to as being “coupled” or “connected” to another element, it can be directly coupled or connected to the other element or an intervening element may be present. In contrast, when an element is referred to as being “directly coupled” or “directly connected” to another element, there is no intervening element present.

The terms used herein is for the purpose of describing specific embodiments only and are not intended to limit the present invention. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Some terms used herein are defined as follows.

Nominal Capacity (Nominal Capa.) refers to a set capacity [Ah] of the battery which is set by a battery manufacturer during development.

State of Charge (SOC) refers to a current state of charge of a battery, represented in percent points [%], and State of Health (SOH) may be a current condition of a battery compared to its ideal or original conditions, represented in percent points [%].

A battery rack refers to a system of a single structure assembled by connecting packs (or modules) set by a battery manufacturer in series/parallel, which can be monitored and controlled by a battery management system (BMS). A battery rack may include several battery packs (or modules) and a battery protection unit or any other protection device.

A battery bank refers to a group of large-scale battery rack systems configured by connecting several racks in parallel. A bank BMS for a battery bank may monitor and control several rack BMSs, each of which manages a battery rack.

A battery section controller (BSC) refers to a device that controls the topmost level of a battery system including a bank level battery system and is also used as a control device in a battery system with a multiple bank level structure.

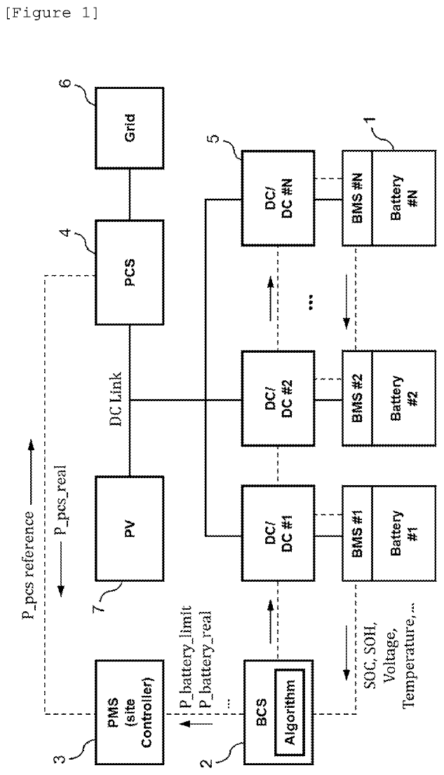

FIG. 1 is a block diagram of an energy storage system to which the present invention may be applied.

FIG. 1 shows an example of a DC coupled system in which an output terminal of a photovoltaic system (PV) 7 is connected to an output terminal of a DC/DC converter 5 and an input terminal of a PCS 4.

In an energy storage system (ESS), a battery is used for storing energy or power, and multiple battery modules may form a battery rack and multiple battery racks may form a battery bank. Here, depending on a device or a system in which the battery is used, a battery rack may be referred to as a battery pack. Battery #1, battery #2, . . . , battery #N shown in FIG. 1 may be in a form of a battery pack or battery rack.

Here, a battery management system (BMS) may be installed for each battery (1). The BMS may monitor a current, a voltage and a temperature of each battery rack (or pack) to be managed, calculate a state of charge (SOC) of the battery based on monitoring results to control charging and discharging. When each battery is a battery rack in the system of FIG. 1, the BMS may be a rack BMS (RBMS).

A battery section controller (BSC) (2) may be located in each battery section which includes a plurality of batteries, peripheral circuits, and devices to monitor and control objects such as a voltage, a current, a temperature, and a circuit breaker.

Furthermore, a power conversion/conditioning system (PCS) 4 installed in each battery section controls power supplied from the outside and power supplied from the battery section to the outside and may include a DC/AC inverter. In addition, the output of the DC/DC converter 5 may be connected to the power conversion system 4 and the power conversion system 400 may be connected to a power grid 6. The PCS 4 normally operates in a constant power mode. A power management system (PMS) or an energy management system (EMS) 3 connected to the power conversion system may control output of the power conversion system based on monitoring and control results of the BMS or BSC.

Meanwhile, CAN (Controller Area Network) or Ethernet may be used for communication (indicated by a dotted line in FIG. 1) between the BMS, the BSC 2, the PMS 3 and the power conversion system 4.

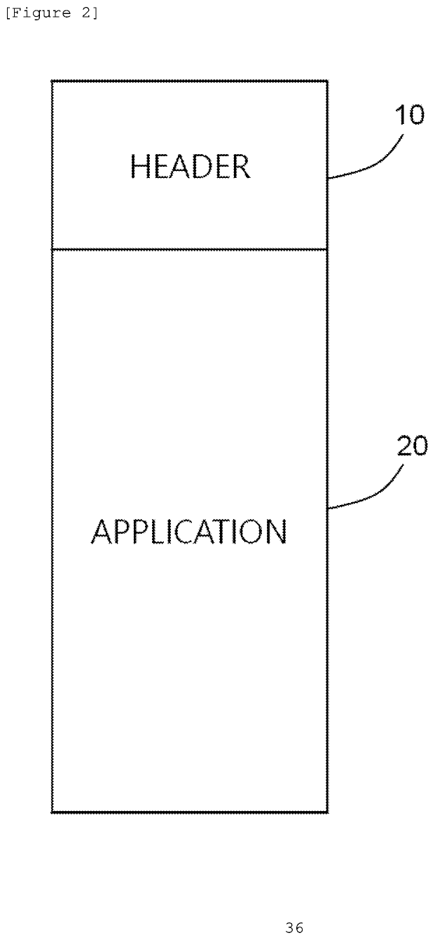

FIG. 2 is a block diagram of a memory included in a typical battery management system.

Among components included in an energy storage system, the battery management system (BMS) is a core component for managing batteries which collects state information of the batteries included in the battery system, diagnoses failure based on the state information, and controls the operating state of the battery through interworking with a high level controller.

The battery management system may perform predefined operations through a management program (eg, firmware) stored in a memory.

Referring to FIG. 2, a memory included in the battery management system may include a header area 10 and an application area 20. The header area 10 may store verification information (e.g., a checksum value) for verifying whether data stored in the application area 20 is changed and the application area 20 may store control logic for battery management and data necessary for control. The battery management system may operate according to a management program stored in the memory.

The battery management system must be certified to meet requirements for functional safety in accordance with relevant laws and regulations. Here, even when the management program of the battery management system is updated during operation of the energy storage system, additional certification is required.

As shown in FIG. 2, in a case of a typical battery management system, even when an item irrelevant to functional safety is updated, a functional safety certification procedure must be performed, since management programs are not functionally separated on memory. Whenever an update of the management program is performed, a certification procedure should be performed, resulting in unnecessary time and expense.

The present invention is presented to solve the problems and proposes a device management system and a program management method thereof, which can improve program management efficiency and minimize unnecessary certification procedures at the same time.

Hereinafter, preferred embodiments according to the present invention will be described in detail with reference to the accompanying drawings.

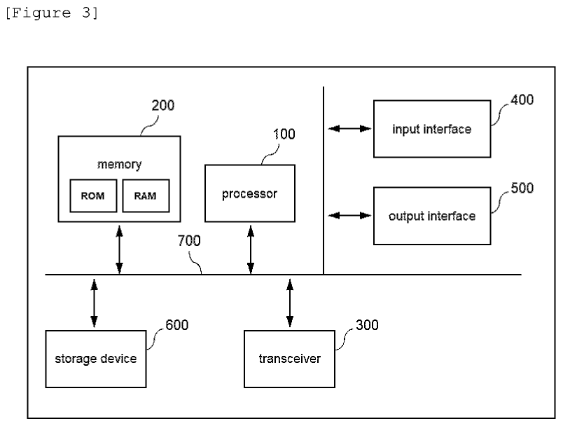

FIG. 3 is a block diagram of a device management system according to embodiments of the present invention.

A device management system according to embodiments of the present invention may be a battery management system (BMS) located in a battery system included in an energy storage system. However, the scope of the present invention is not limited to this, and any apparatus that manages a specific device using a device management program installed in a memory in association with the specific device should be interpreted as a device management system according to the present invention.

The device management system may include at least one processor 100, a memory 200 for storing a device management program including at least one command executed through the at least one processor, and a transceiver 300 connected to a network to perform communication.

The device management program may include a first program related to functional safety of the device and a second program irrelevant to the functional safety of the device. For example, the first program may include a state diagnosis program for diagnosing a state of the battery by measuring voltage, current, and temperature of the battery.

The at least one command executed by the at least one processor may include a command to separately store the first program and the second program in independently partitioned areas within a memory.

The command to store may further include a command to allocate an area where the first program is stored to a fixed location on the memory.

The at least one command may further include a command for separately storing version information of the first program and version information of the second program in the memory.

The at least one command may further include a command to determine one of the first program and the second program as an update target program when the device management program enters an update mode; and a command to independently update the determined update target program.

The at least one command may further include a command to independently update only version information of an updated program, when any one of the first program and the second program is updated.

The device management system may further include an input interface 400, an output interface 500, a storage device 600, and the like. Respective components included in the device management system may be connected by a bus 700 to communicate with each other.

The processor 100 may execute program commands stored in at least one of the memory 200 and the storage device 600. Here, the processor may mean a central processing unit (CPU), a graphics processing unit (GPU), or a dedicated processor on which methods according to embodiments of the present invention are performed. The memory (or storage device) may include at least one of a volatile storage medium and a non-volatile storage medium. For example, the memory may include at least one of read only memory (ROM) and random access memory (RAM).

In embodiments, the device management program according to the present invention may be stored and managed in a non-volatile memory. For example, the device management program may be stored and managed in a read-only memory (ROM).

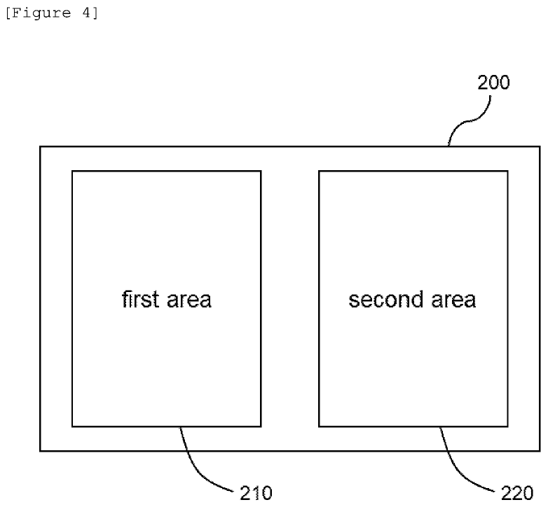

FIG. 4 is a block diagram of a memory included in a device management system according to embodiments of the present invention.

Referring to FIG. 4, the memory 200 may include a first area 210 and a second area 220. Here, the first and second areas may correspond to specific areas which are independently partitioned in the memory.

The device management program according to the present invention may include a first program related to functional safety of the device and a second program unrelated to the functional safety of the device. Here, the processor may separately store the first program in the first area 210 and the second program in the second area 220. In other words, device management programs according to the present invention may be configured to be separated into a safety-related program and a general program and the device management system may be configured to store and manage them independently.

In the embodiments, the first area 210 may be defined to be fixedly allocated to a specific location on a memory. For example, safety-related programs may be defined to be stored in a fixed location in ROM.

Version information for the first program and version information for the second program may be separately stored in the memory 200. In an embodiment, version information for the first program may be stored in the first area 210 and version information for the second program may be stored in the second area 220. Accordingly, even if one of the version information of the first and second programs is changed, the version information of the other program whose version is not changed may be maintained.

The first and second programs may be independently updated. In other words, the first and second programs may not be updated simultaneously, but only one of them may be updated or they may be updated sequentially.

For example, when the device management system enters an update mode of the device management program, the processor may determine any one of the first and second programs as an update target program. Here, the update target program may be determined based on an identifier included in an update file being input. Thereafter, the processor may independently update only the determined update target program.

When any one of the first program and the second program is updated, only version information of the updated program may be independently updated. For example, when a second program unrelated to functional safety is updated, the processor may change only the version information of the second program (from V1 to V2). Here, since version information of the first program, which is a functional safety-related program, is maintained, a separate functional safety certification procedure for the device may not be performed.

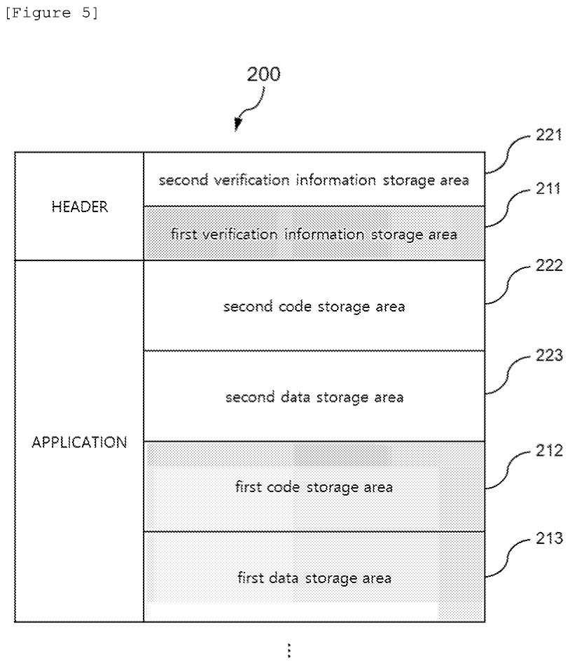

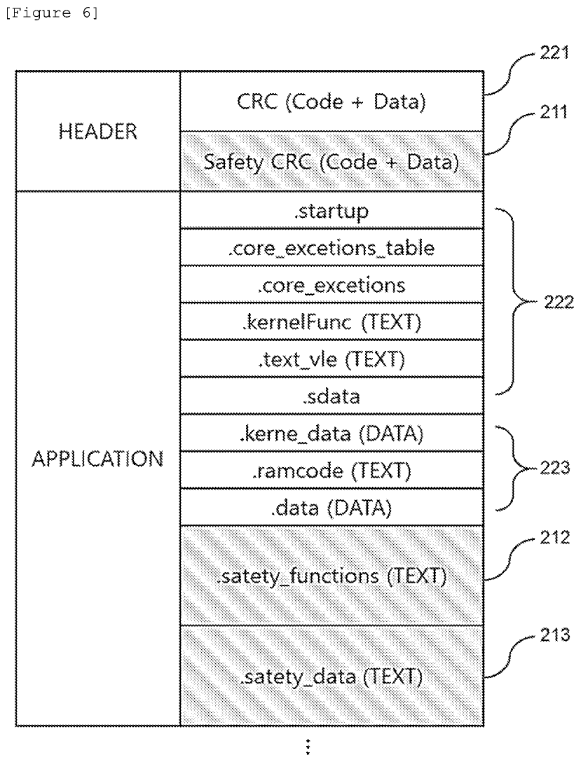

FIG. 5 illustrates partitioned areas of memory according to embodiments of the present invention and FIG. 6 shows an example of a memory according to embodiments of the present invention.

The memory 200 may include a first area and a second area. Here, the first area may be configured to store a first program related to functional safety of the device, and the second area may be configured to store a second program unrelated to the functional safety.

Referring to FIG. 5, the first area may include a first verification information storage area 211, a first code storage area 212, and a first data storage area 213, and a second area may include a second verification information storage area 221, a second code storage area 222, and a second data storage area 223.

The verification information storage area may store verification information for verifying whether data stored in another area is changed. For example, the verification information storage area may store a checksum value for a cyclic redundancy check (CRC).

The code storage area may store logic for managing or controlling the device. For example, the code storage area may store codes for monitoring, diagnosing, or controlling the device.

The data storage area may store data required for device management or control.

The first verification information storage area 211 and the second verification information storage area 221 are included in a header area of the memory 200, and the first code storage area 212, the first data storage area 213, the second code storage area 222, and the second data storage area 223 may be included in an application area of the memory 200.

The first code storage area 212 may store diagnosis logic related to functional safety of the device, and the first data storage area 213 may store set values related to the diagnosis logic stored in the first code storage area 212. For example, when the device management system according to the present invention is a battery management system located in a battery system, the first code storage area 212 may store measurement logic of voltage, current, and temperature for diagnosing a state of the battery and state diagnosis logic based on measured values. Furthermore, the first data storage area 213 may store set values of diagnosis (eg, a reference threshold value, etc.) for diagnosing a battery state.

Referring to FIG. 6, the memory 200 according to embodiments of the present invention may include a first verification information storage area 211 and a second verification information storage area 221 in the header area, and include a first code storage area 212, a first data storage area 213, a second code storage area 222, and a second data storage area 223 in the application area.

The first verification information storage area 211 may store verification information (e.g., [Safety CRC (Code+Data)]) for verifying whether the first program stored in the first areas 212 and 213 is changed. As a specific example, the first verification information storage area 211 may store a checksum value for a cyclic redundancy check (CRC).

In addition, the second verification information storage area 221 may store verification information (e.g., [CRC (Code+Data)]) for verifying whether the second programs stored in the second areas 222 and 223 are changed.

The first code storage area 212 may store diagnosis logic (e.g., [.satety_functions (TEXT)]) related to functional safety of the device, and the first data storage area 213 may store set values (eg, [.satety_data (TEXT)]) related to the diagnosis logic stored in the first code storage area 212.

In addition, the second code storage area 222 may store control logic unrelated to the functional safety of the device (e.g., [.startup], [.core_excetions_table], [.core_excetions], [.kernelFunc (TEXT)], [.text_vle (TEXT)], [.sdata]), and the second data storage area 223 may store data related to the control logic stored in the second code storage area 222 (For example, [.kerne_data (DATA)], [.ramcode (TEXT)], [.data (DATA)]).

Referring to FIGS. 5 and 6, the first program according to the present invention is stored in the first areas 211, 212, and 213, and the second program is stored in the second areas 221, 222, and 223, and thus, they may be managed independently.

When data stored in at least one of the first code storage area 212 and the first data storage area 213 is changed, the processor may update the verification information stored in the first verification information storage area 211 of the first area. For example, when data stored in the first code storage area 212 and the first data storage area 213 is changed due to an update of the first program, the processor may create a new value for a checksum stored in the first verification information storage area 211 based on the changed data and update the version information of the first program.

In addition, when data stored in at least one of the second code storage area 222 and the second data storage area 223 is changed, the processor may update the verification information stored in the second verification information storage area 221 of the second area. For example, when data stored in the second code storage area 222 and the second data storage area 223 is changed due to an update of the second program, the processor may create a new value for a checksum stored in the second verification information storage area 221 based on the changed data and update the version information of the second program.

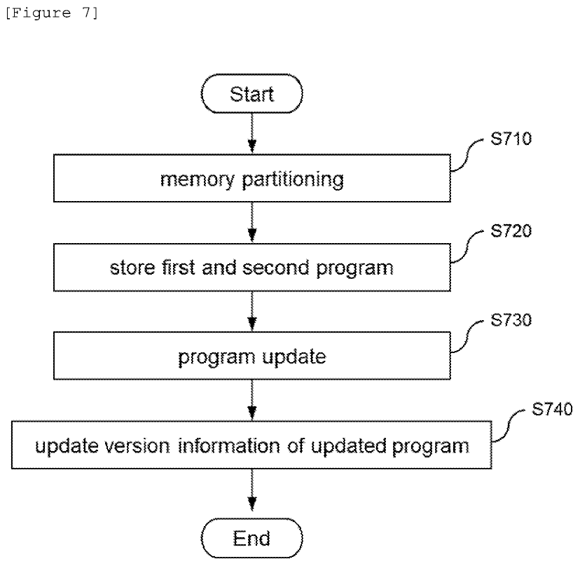

FIG. 7 is an operation flowchart of a program management method according to embodiments of the present invention.

The processor may perform partitioning the memory into a first area and a second area (S710). Here, the first area may be defined to be fixedly allocated to a specific location on a non-volatile memory.

The processor may store a first program related to functional safety of the device in the first area, and store a second program unrelated to the functional safety of the device in the second area (S720). Here, the processor may store version information of the first program and version information of the second program in the first area and the second area, respectively.

The processor may independently update the first and second programs (S730). For example, when the device management system enters an update mode of the device management program, the processor may determine any one of the first and second programs as an update target program based on an identifier included in an update file being input. Thereafter, the processor may independently update only the determined update target program.

When any one of the first program and the second program is updated, the processor may independently update only the version information of the updated program (S740). For example, when a second program unrelated to functional safety is updated, the processor may change only the version information of the second program (from V1 to V2). Here, since the version information of the first program, which is a functional safety-related program, is maintained, a separate functional safety certification procedure for the device may not be performed.

The operations of the method according to the embodiments of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system to store and execute computer-readable programs or codes in a distributed manner.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus. Some or all of the method steps may be performed by (or using) a hardware device, such as, for example, a microprocessor, a programmable computer, or an electronic circuit. In some embodiments, one or more of the most important method steps may be performed by such an apparatus.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A device management system configured to interconnect with a device, the device management system comprising:
at least one processor; and
a memory configured to store a device management program including at least one instruction executed by the at least one processor,
wherein the at least one processor is configured to stores a first program and a second program independently in separately partitioned areas in the memory, wherein the first program is related to functional safety of the device and the second program is unrelated to the functional safety of the device.

2. The device management system of claim 1, wherein the at least one processor is configured to independently stores version information of the first program and version information of the second program in the separately partitioned areas of the memory.

3. The device management system of claim 2, wherein the at least one processor is configured to in response to at least one of the first program and the second program being updated, update the version information of the updated first program or the second program.

4. The device management system of claim 1, wherein, when an update mode of the device management program is initiated, the at least one processor is configured to in response to only one of the first program or the second program requiring an update, update the one of the first program or the second program that requires the update; and in response to both the first program and second program requiring an update, update the first program before the second program.

5. The device management system of claim 1, wherein the partitioned areas of the memory include a first area in which the first program is stored and a second area in which the second program is stored; and
Wherein the first area is assigned to a fixed specific location on the memory.

6. The device management system of claim 5, wherein each of the first area and the second area includes:
a verification information storage area in which verification information about whether data stored in each area is changed;
a code storage area for storing control logic for the device; and
data storage area for storing data necessary for management or control of the device.

7. The device management system of claim 6, wherein a first code storage area included in the first area stores diagnosis logic related to the functional safety of the device, and
a first data storage area included in the first area stores set values related to the diagnosis logic.

8. The device management system of claim 7, wherein the at least one processor is configured to update verification information stored in a first verification information storage area of the first area when the data stored in at least one of the first code storage area and the first data storage area is changed.

9. The device management system of claim 1, wherein the memory is a non-volatile memory.

10. The device management system of claim 1, wherein the device management system is a battery management system located within a battery system.

11. A program management method of a device management system including at least one processor and a memory for storing a device management program, the program management method comprising:
storing, by the processor, a first program and a second program independently in separately partitioned areas in the memory, wherein the first program is related to a functional safety of the device and the second program is unrelated to the functional safety of the device; and
storing, by the processor, version information of the first program and version information of the second program independently, in the separately partitioned areas of the memory.

12. The program management method of claim 11, further comprising independently updating only version information of an updated program, in response to at least one of the first program and the second program being updated.

13. The program management method of claim 11, further comprising:
determining one of the first program and the second program as an update target program when an update mode of the device management program is initiated; and
independently updating the determined update target program.

14. The program management method of claim 11, further comprising: allocating an area where the first program is stored in a fixed specific location on the memory.

15. The program management method of claim 11, wherein the memory includes a first area in which the first program is stored; and a second area in which the second program is stored, and
each of the first area and the second area includes:
a verification information storage area in which verification information about whether data stored in each area is changed;
a code storage area for storing control logic for the device; and
data storage area for storing data necessary for management or control of the device.

16. The program management method of claim 15, further comprising storing diagnosis logic related to the functional safety of the device in a first code storage area included in the first area and storing set values related to the diagnosis logic in a first data storage area included in the first area.

17. The program management method of claim 16, further comprising, updating verification information stored in a first verification information storage area of the first area when the data stored in at least one of the first code storage area and the first data storage area is changed.
